(19) United States
(12) Patent Application Publication
(10) Pub. No.: US 2018/0243156 A1
(43) Pub. Date: Aug. 30, 2018

(54) Biomechanical Weight-Bearing Crutch

(71) Applicant: Andrew Hajime Tryba, Austin, TX (US)

(72) Inventor: Andrew Hajime Tryba, Austin, TX (US)

(21) Appl. No.: 15/904,295

(22) Filed: Feb. 23, 2018

Related U.S. Application Data
(60) Provisional application No. 62/463,264, filed on Feb. 24, 2017.

(51) Int. Cl. A61H 3/02

(52) U.S. Cl. CPC A61H 3/02; A61H 2205/088; A61H 2003/007; A61H 2201/1616; A61H 2201/1642

(57) ABSTRACT

The present disclosure includes a biomechanical weight-bearing crutch that may replace conventional crutches in use today. Unlike conventional crutches, the crutch of the present disclosure enables a user to immediately walk in a hands-free fashion. The biomechanical weight-bearing crutch is a form fitting device that can be worn inside or outside of the user's clothes. The movement of the crutch is automatically and synchronously performed as part of the gait motion, instead of today's cumbersome crutch motion where the users have to physically lift and move the crutch.

### CROSS REFERENCE TO RELATED APPLICATION

The present application claims priority to U.S. Provisional Patent Application Ser. No. 62/463,264, filed on Feb. 24, 2017, the entire contents of which is herein incorporated by reference.

### BACKGROUND

The present disclosure is in the field of medical devices. More particularly, the present disclosure is in the medical field of weight-bearing crutch devices.

According to the CDC, 575,000 people are prescribed crutches in the United States and approximately 7 million people around the world use crutches. Amazingly, a vast majority of crutches used today are the same design (and include the same flaws) as crutches from the 1800s. One such design flaw is the substantial pressure on the hands or wrists that potentially may causing a variety of additional injuries. Additionally, nearly all crutches require the user to learn how to maneuver the complicated crutch gait (i.e., the motion of walking with a crutch)—putting the user at risk of additional injury due to the unnatural, unfamiliar, and cumbersome movements.

### SUMMARY

In one example, the present disclosure includes a medical device. The medical device includes a shoulder support configured to contact an armpit region of a user. The medical device also includes a rotatable hip joint. The medical device further includes a foot support. Additionally, the medical device includes an upper linkage configured to couple the shoulder support to the rotatable hip joint. The medical device further includes a lower linkage configured to couple the rotatable hip joint to the foot support.

In some examples, the medical devices further includes at least one strap configured to hold the medical device against the user. The medical device may also include at least one of a chest strap, a waist strap, and a leg strap. In various examples, the medical device may further include a knee joint positioned between the rotatable hip joint and the foot support. The lower linkage may include a first lower linkage component configured to couple the rotatable hip joint to the knee joint and a second lower linkage component configured to couple the knee joint to the foot support. At least one of the knee joint and the hip joint may be configured to be selectively lockable. At least one of the knee joint and the hip joint may be configured to have a reduced range of motion. The foot support may further include an ankle joint, where the ankle joint is configured to be selectively lockable at an ankle angle. In some examples, the foot support further includes a foot extension configured to mount under a foot of the user. Examples also include at least one of the upper linkage and the lower linkage being configurable to have an adjustable length.

In one example, the present disclosure includes a method for fitting a medical device to a user. The method includes setting an upper linkage length based on a distance between a hip of the user and the armpit region of the user. The method also includes setting a lower linkage length based on a distance from a ground surface to the hip of the user. Additionally, the method includes coupling the medical device to the user.

In some examples, setting the lower linkage length includes setting a first lower linkage length based on a distance between the hip of the user and a knee of the user and setting a second lower linkage length based on a distance from the ground surface to the knee of the user. In some examples, the method also includes setting a hip rotational range for a hip joint of the medical device. The hip rotational range may be zero such that the hip is fixed at a given angle. The method may also include setting a knee rotational range for a knee joint of the medical device. The knee rotational range may be zero such that the knee is fixed at a given angle. The method may also include setting an ankle rotational range for an ankle joint of the medical device. The ankle rotational range may be zero such that the ankle is fixed at a given angle. As part of the method, coupling the medical device to the user includes strapping the medical device to the user. Strapping the medical device to the user may include one or more of affixing a chest strap from the medical device to the user, affixing a waist strap from the medical device to the user, affixing a thigh strap from the medical device to the user, and affixing a calf strap from the medical device to the user.

In one example, the present disclosure includes an apparatus. The apparatus includes a shoulder support configured to contact an armpit region of a user, a rotatable hip joint, a rotatable knee joint, a rotatable ankle joint, a foot support coupled to the rotatable ankle joint, an upper linkage configured to couple the shoulder support to the rotatable hip joint, a thigh linkage configured to couple the rotatable hip joint to the rotatable knee joint, a tibia linkage configured to couple the rotatable knee joint to the rotatable ankle joint, a plurality of straps, where the straps are configured to couple the apparatus to the user. Additionally, at least one of the rotatable hip joint, the rotatable knee joint, or the rotatable ankle joint may be configured to be selectively locked at a predetermined angle.

### BRIEF DESCRIPTION OF THE DRAWINGS

FIG. 1 illustrates a biomechanical weight-bearing crutch, according to an example embodiment.

FIG. 2A illustrates various components of the biomechanical weight-bearing crutch, according to an example embodiment.

FIG. 2B illustrates various components of the biomechanical weight-bearing crutch, according to an example embodiment.

FIG. 2C illustrates various components of the biomechanical weight-bearing crutch, according to an example embodiment.

FIG. 3 illustrates the biomechanical weight-bearing crutch positioned on a user, according to an example embodiment.

FIG. 4 illustrates a method of using the biomechanical weight-bearing crutch, according to an example embodiment.

### DETAILED DESCRIPTION

The present disclosure is a biomechanical weight-bearing crutch that may replace common crutches as used today, and enables a user to immediately walk in a familiar hands-free fashion. The biomechanical weight-bearing crutch is a form-fitting device that can be worn inside or outside of the user's clothes. The crutch transfers forces around the injured joint of the user—but unlike today's standard crutch that relies on hand/wrist pressure and underarm pressure to move the energy directly to the floor—the biomechanical weight-bearing crutch uses bypass force dynamics to divert energy around the injured portion of the body which not only provides stability but also reduces the load on the muscles. The movement of the crutch is automatically and synchronously performed as part of the gait motion instead of today's cumbersome crutch motion where the users have to physically lift and move the crutch. The biomechanical weight-bearing crutch can accommodate a variety of leg and joint injuries because the bypass force dynamics can be configured to bypass the specific portion of the leg or joint that is injured.

The hands-free biomechanical weight-bearing crutch enables the user to walk (or run) in a hands-free fashion. The user no longer has to perform a crutch gait as the lightweight device is strapped to the user—which enables the device to match the natural motion of the body—yet transfer the force of the body weight around the injured joint. The gait motion of the user's legs are automatically performed and supported without today's cumbersome crutch motion. The biomechanical weight-bearing crutch can accommodate a variety of leg injuries because the weight of the body is transferred around the injured joint.

Similar to nailing a two-by-four piece of lumber to the side of a rotting fence post to transfer the weight around the failing section, the hands-free biomechanical weight-bearing crutch this same theory to transfer forces around an injured leg joint (hip, knee or ankle). The crutch may use a thin, lightweight but highly compressible material to behave as an exoskeleton to that specific joint. The crutch may further include a series of lockable hinges to enable mobility.

In some examples, the hands-free biomechanical weight-bearing crutch may be made of metal, plastic, carbon fiber, or other suitable materials. For some users, such as those who will not complete vigorous physical activity while wearing the crutch, thinner and more lightweight materials may be used. For other users, such as runners or those who will participate in vigorous physical activity, stronger materials may be used to support the user's body weight as well as forces from the activity.

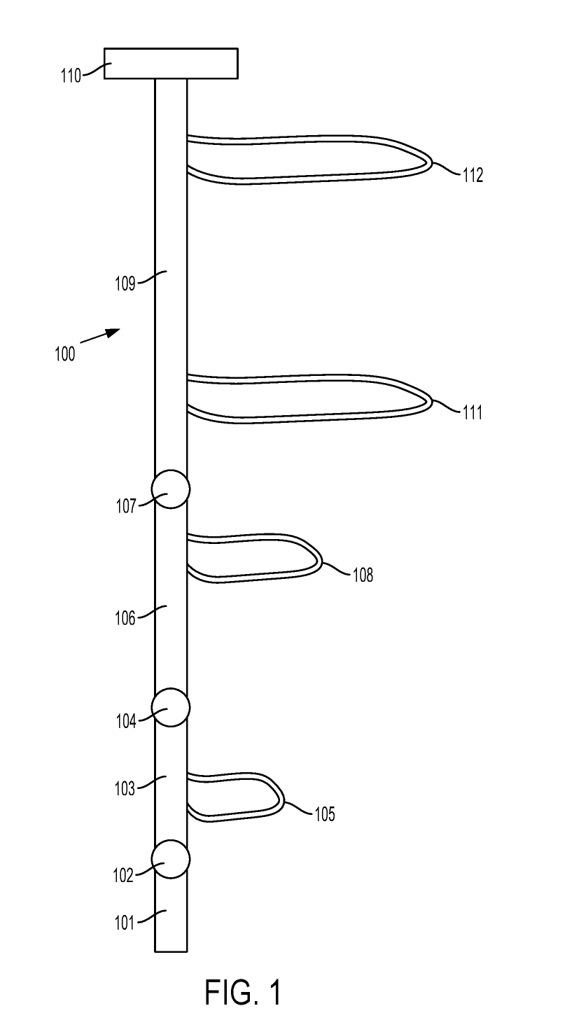

FIG. 1, presents a block diagram of the various components of one example of the hands-free biomechanical weight-bearing crutch 100. In various different examples, some components may be omitted or other components may be added to the crutch. As shown in FIG. 1, in some examples, there are seven major components to the device.

The foot support 101 is where the device touches the ground (or inside a user's shoe). The foot support 101 may be a flat plate the goes under a foot of the user of the crutch. The user may step on the plate as he or she walking while wearing the crutch. In other examples, the foot support 101 may not go under the user's foot, but may rather contact the ground in the region near the user's foot, but not necessarily underneath. In some examples, the foot support 101 may include a strap component that affixes the foot support 101 to the foot of the user of the crutch. The foot support portion 101 may also include an ankle joint 102 in some examples, as shown in FIG. 1.

In some examples, the foot support 101 can be worn inside or outside of the shoe and transfer weight to the ground. If worn external of the shoe, the foot support 101 may include a rubber (or other non-slip material) end to keep the end from slipping on the ground. If worn inside of the shoe, the foot support 101 may be shaped in an ergonomic shape for the comfort of the user. In other examples, the foot support 101 may be smaller than the size of the user's foot so it can fit more easily inside of the user's shoe. The foot support 101 may also add stability to the device by distributing the user's body weight across the ground. The foot support 101 may enable the crutch to bear a portion of the weight of the user wearing the crutch.

The foot support 101 may be connected to the ankle joint 102. In some examples, the ankle joint 102 may rotate as the user goes through the walking motion—much like a human ankle. The ankle joint 102 may enable a more natural movement of the user's foot and the connected foot support 101. The ankle joint 102 may include a bearing to enable rotation while still supporting the load forces from the components above it. Generally, the ankle joint 102 may have a range of motion from about 30 degrees to about 150 degrees. However, in some other examples, the ankle joint 102 may have an adjustable range of motion controlled by the user (and/or the user's doctor) to prevent undesired bending of the user's ankle. In some other examples, the ankle joint 102 may be selectively locked at a given angle to prevent any bending of the ankle joint 102.

The tibia section 103 may extend from the ankle joint 102 to the bottom of the knee joint 104. The tibia section 103 may extend vertically to accommodate users of different heights. The tibia section 103 may be manufactured of a thin and light but high compression capable material (such as carbon fiber as one particular example). The tibia section 103 may include a strap 105 (or other connection means) that temporarily connects the tibia section 103 to the user's lower leg.

The knee joint 104 is load-bearing joint that may bend and function in a similar manner to a user's knee. Similar to the ankle joint 102, the knee joint 104 may have a range of angles over which it may bend similar to that of a human. In another example, the knee joint 104 may have a range of motion from about 0 degrees (straight) to about 180 degrees (folded for storage of the crutch device). As such, the knee joint 104 may be designed such that it does not rotate negative to protect the knee from hyperextension. Additionally, the knee joint 104 may have an adjustable range of motion controlled by the user (and/or the user's doctor) to prevent undesired bending of the user's knee.

For certain injuries (such as knee injuries)—the knee joint 104 may stay in a locked position when the user is walking to remove forces around the knee. Thus, in some examples, the knee joint 104 may be selectively locked at a given angle to prevent any bending of the knee joint 104.

In another example, the knee joint 104 may be controllably locked by the user of the crutch. For example, the user may engage the lock when the user is walking and unlocked when the user attempts to sit. The locking and unlocking can either be done through a button, through a mechanical spin/lock joint, electronically, as examples.

The locking mechanisms described herein may be functional to lock a respective joint at a particular angle. When the joint is locked, the lock prevents any rotation of the respective joint. Similarly, each joint may have standard range of motion and a reduced range of motion. In some examples, the standard range of motion may correspond to a maximum range of motion for the respective joint. In other examples, the standard range of motion may be greater than the maximum range of motion for the respective joint in order to allow the crutch to fold to be compact for storage. The reduced range of motion may correspond to a range of motion that is less than the maximum range of motion. The reduced range of motion may be set based on a comfort level of the user, based on reducing strain on an injury, and/or a limit of the user's range of motion. In various examples, some or all of the joints may be able to be locked and or have a reduced range of motion set.

The femur section 106 extends from the top of the knee joint 104 to the bottom of the hip joint 107. Similar to the tibia section 103, the femur section 106 may extend vertically to accommodate users of different user heights. Also like the tibia section 103, the femur section 106 may be manufactured of a thin and light but high compression capable material (such as carbon fiber as on particular example). The femur section 106 may include a strap 108 that connects the femur section 106 to the user's thigh.

The hip joint 107 is a load-bearing joint that may be similar to the knee joint 104. The hip joint 107 may be unlocked when the user is walking and sitting. The hip joint 107 may have the ability to lock if the user requires additional support of the hip (as described above). The locking and unlocking can either be done through a button or through a mechanical spin/lock joint, as examples. In some examples, the hip joint 107 may have a range of rotation from about negative 30 degrees to about 180 degrees (folded).

The torso section 109 may extend from the hip joint 107 to the shoulder support 110. Similar to the tibia and femur sections 103, 106—the torso section 109 may extend vertically to accommodate users of different user heights. Also like those sections, the torso section 109 may be manufactured of a thin and light but high compression capable material (such as carbon fiber as one particular example). The torso section 109 may also include an optional hinge that folds when it detects the user is sitting down. This signal may come from the hip joint 107 upon the hip joint extending beyond 90 degrees. The torso section may include two straps 111, 112. The first strap 111 may be used to connect the torso section 109 to the user's lower abdomen, and the second strap 112 may be used to connect the torso section 109 to the user's upper chest.

The shoulder support 110 may run substantially perpendicular to the torso section 109 and may be configured to rest under the user's armpit when in use. The shoulder support 110 may be positioned in the area near or in the user's armpit in order to help support the weight of the user's body through the crutch apparatus. The shoulder support 110 may be about 6 inches in length, may be slightly concave, and may be cushioned for the user's comfort. The diameter of the shoulder support 110 may be about 3 inches including the cushion. The shoulder support 110 may also include a removable cloth cover that intended to be washed as appropriate.

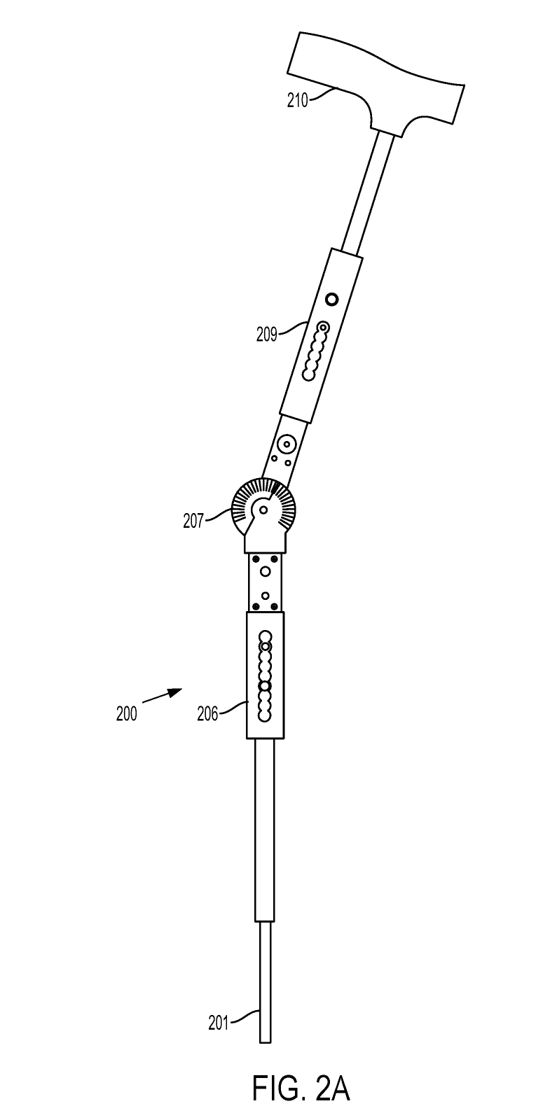

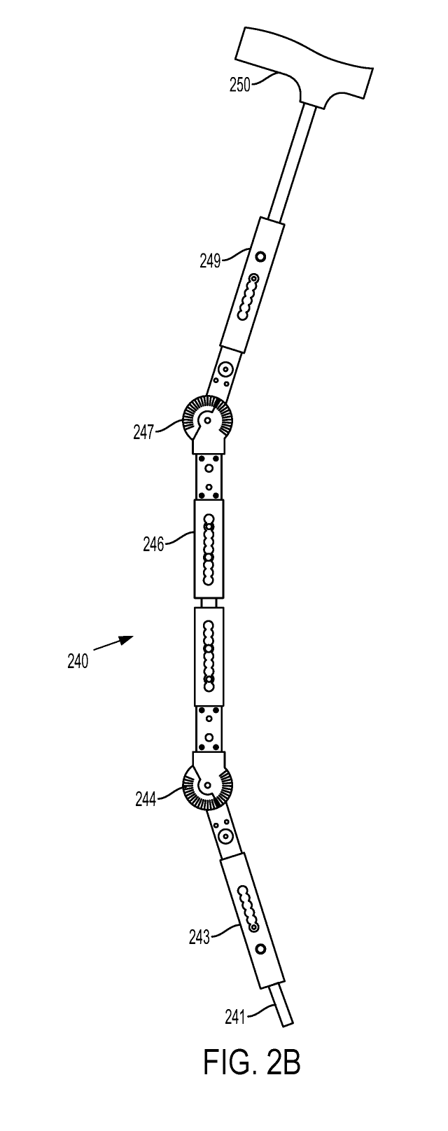

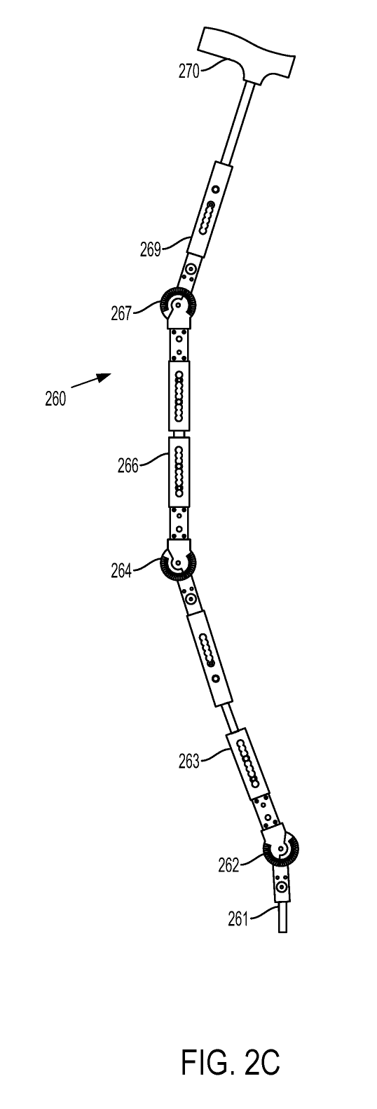

FIG. 2A through 2C present various different example configurations of the hands-free biomechanical weight-bearing crutch. Other examples are possible as well. The linkages described with respect to FIGS. 2A-2C may be similar to the tibia, torso, and femur sections described with respect to FIG. 1 and each linkage may or may be able to have its length adjusted. In some examples, the tibia and femur sections may be combined as a single linkage. Additionally, each of the joints may be lockable and ranges of rotation as described with respect to FIG. 1. Further, the straps described with respect to FIG. 1 have been omitted from FIGS. 2A-2C.

FIG. 2A illustrates various components of the biomechanical weight-bearing crutch 200, according to an example embodiment. The biomechanical weight-bearing crutch 200 may be similar to the previously-discussed hands-free biomechanical weight-bearing crutch 100 of FIG. 1.

Biomechanical weight-bearing crutch 200 may include a foot support 201, a hip joint 207, and a shoulder support 210. The foot support 201 may be coupled to the knee joint by way of the lower linkage 206. The hip joint 207 may be coupled to the shoulder support 210 by way of the upper linkage 209.

In practice, biomechanical weight-bearing crutch 200 may be used in a situation when a user wants little or no movement of their knee (and possibly ankle). Thus, biomechanical weight-bearing crutch 200 only provides a rotational joint at hip joint 207. The hip joint 207 may have a controllable range of motion and locking features.

FIG. 2B illustrates various components of the biomechanical weight-bearing crutch 240, according to an example embodiment. The biomechanical weight-bearing crutch 240 may be similar to the previously-discussed hands-free biomechanical weight-bearing crutch 100 of FIG. 1.

Biomechanical weight-bearing crutch 240 may include a foot support 241, a knee joint 244, a hip joint 247, and a shoulder support 250. The foot support 241 may be coupled to the knee joint by way of the second lower linkage 243. The knee joint 244 may be coupled to the hip joint by way of the first lower linkage 246. The hip joint 247 may be coupled to the shoulder support 270 by way of the upper linkage 249.

In practice, biomechanical weight-bearing crutch 240 may be used in a situation when a user wants little or no movement of their ankle. Thus, biomechanical weight-bearing crutch 240 only provides a rotational joint at hip joint 247 and knee joint 244. Both hip joint 247 and knee joint 244 may have a controllable range of motion and locking features.

FIG. 2C illustrates various components of the biomechanical weight-bearing crutch 240, according to an example embodiment. The biomechanical weight-bearing crutch 240 may be similar to the previously-discussed hands-free biomechanical weight-bearing crutch 100 of FIG. 1.

Biomechanical weight-bearing crutch 240 may include a foot support 261, an ankle joint 262, a knee joint 264, a hip joint 267, and a shoulder support 270. The ankle joint 262 may be coupled to the knee joint by way of the second lower linkage 263. The knee joint 264 may be coupled to the hip joint by way of the first lower linkage 266. The hip joint 267 may be coupled to the shoulder support 270 by way of the upper linkage 269.

In practice, biomechanical weight-bearing crutch 260 may be used in a situation when a user may want movement of one or more of their ankle, knee, and hip. Thus, biomechanical weight-bearing crutch 260 provides a rotational joint at hip joint 267, knee joint 264, and ankle joint 262. The hip joint 267, knee joint 264, and ankle joint 262 may have a controllable range of motion and locking features.

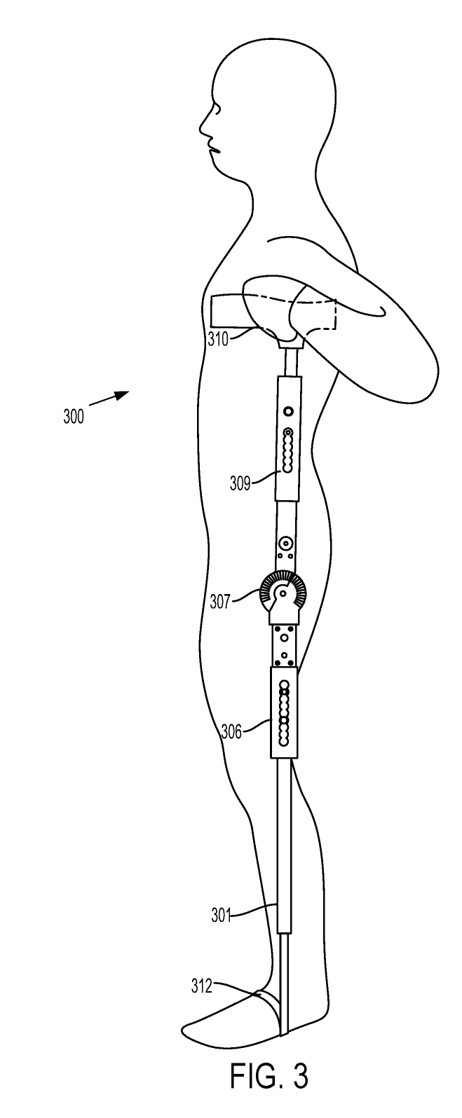

FIG. 3 illustrates the biomechanical weight-bearing crutch 300 positioned on a user, according to an example embodiment. The biomechanical weight-bearing crutch 300 may be similar to the previously-discussed hands-free biomechanical weight-bearing crutches of FIGS. 1 through 2C.

Biomechanical weight-bearing crutch 300 may include a foot support 301 having a foot strap 312, a hip joint 307, and a shoulder support 310. The foot support 301 may be coupled to the knee joint by way of the lower linkage 306. The hip joint 307 may be coupled to the shoulder support 310 by way of the upper linkage 309.

In practice, biomechanical weight-bearing crutch 300 may be used in a situation when the user wants little or no movement of their knee (and possibly ankle). Thus, biomechanical weight-bearing crutch 300 only provides a rotational joint at hip joint 307. The hip joint 307 may have a controllable range of motion and locking features. Although FIG. 3 is shown with only a single rotational joint at the hip, other combinations (with more joints) are possible as well. For example, the two or three joint configures described with respect to FIGS. 2B and 2C may be used in the body-worn situation of FIG. 3 as well.

Additionally, FIG. 3 shows how the upper linkage 309 and the lower linkage have lengths that may be adjusted to fit a respective user. In examples where there are two lower linkages, the two lower linkages may have lengths that correspond to placing the knee joint near a knee of user.

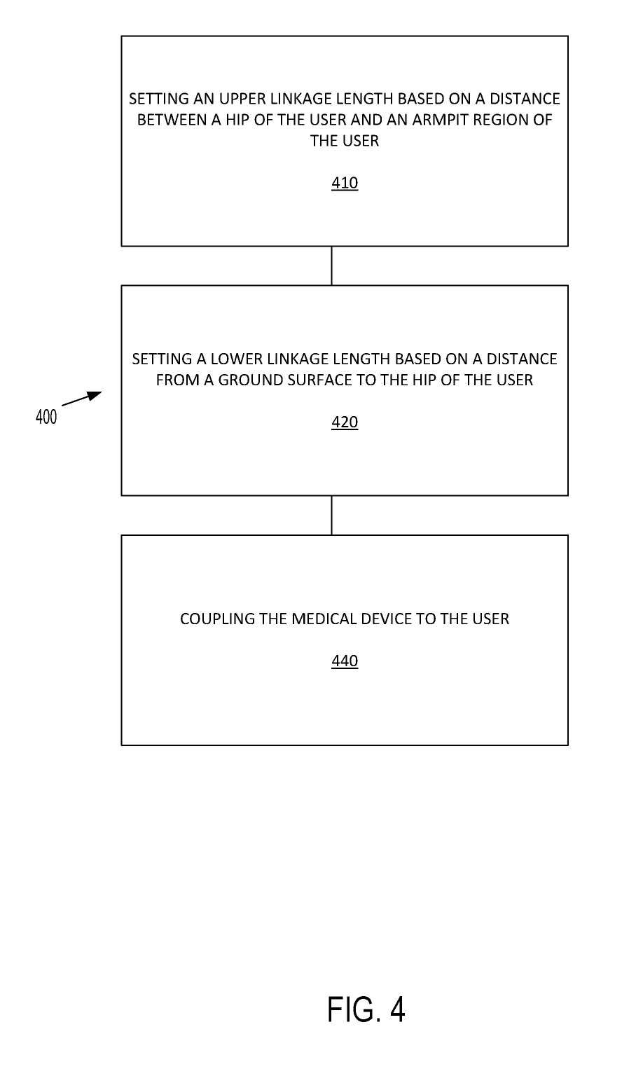

FIG. 4 illustrates an example method 400 of using the biomechanical weight-bearing crutch. Method 400 may be used in conjunction with the various devices shown in FIGS. 1-4, or similar crutch structures. Although the blocks are shown in a linear manner, each block does not necessarily need to be performed in a sequential manner. For example, the order of the blocks may be switched or performed in parallel.

At block 410 method 400 includes setting an upper linkage length based on a distance between a hip of the user and an armpit region of the user. To fit the crutch to the user, the upper linkage may have a length that positions the hip joint approximately near a hip of of the user when the shoulder support is positioned near the armpit to support the weight of the user.

At block 420 method 400 includes setting a lower linkage length based on a distance from a ground surface to the hip of the user. Additionally, to fit the crutch to the user, the lower linkage may have a length that positions the hip joint approximately near a hip of of the user when the foot support is positioned near the foot (i.e., under the foot or adjacent to the foot) to support the weight of the user.

At block 440 method 400 includes coupling the medical device to the user. Coupling the device to the user may include fitting straps around various portions of the user. In some examples, straps may be omitted. Straps may be omitted if the device is worn under the clothing as a user's belt may support the crutch in the correct position.

As previously discussed, in some examples, setting the lower linkage length includes setting a first lower linkage length based on a distance between the hip of the user and a knee of the user and setting a second lower linkage length based on a distance from the ground surface to the knee of the user. In some examples, the method also includes setting a hip rotational range for a hip joint of the medical device. The hip rotational range may be zero such that the hip is fixed at a given angle. The method may also include setting a knee rotational range for a knee joint of the medical device. The knee rotational range may be zero such that the knee is fixed at a given angle. The method may also include setting an ankle rotational range for an ankle joint of the medical device. The ankle rotational range may be zero such that the ankle is fixed at a given angle. As part of the method, coupling the medical device to the user includes strapping the medical device to the user. Strapping the medical device to the user may include one or more of affixing a chest strap from the medical device to the user, affixing a waist strap from the medical device to the user, affixing a thigh strap from the medical device to the user, and affixing a calf strap from the medical device to the user.

The advantages of the present disclosure include, without limitation, health and convenience benefits to the user. Prior to the content of this disclosure, the user would be required to risk wrist and arm injury and lose significant mobility with a standard crutch. Now, in practice, the user has no additional arm and wrist risk and gain significant convenience from the ability to walk around in a near-normal manner. Future versions of the hands-free biomechanical weight-bearing crutch could be made to accommodate more strenuous activities than walking—such as biking or running.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The claims should therefore not be limited by the above described embodiments, methods, and examples, but by all embodiments and methods.

1) A medical device comprising:
a shoulder support configured to contact an armpit region of a user;
a rotatable hip joint;
a foot support;
a upper linkage configured to couple the shoulder support to the rotatable hip joint;
a lower linkage configured to couple the rotatable hip joint to the foot support.

2) The medical device of claim 1, further comprising at least one strap configured to hold the medical device against the user.

3) The medical device of claim 2, further comprising at least one of a chest strap, a waist strap, and a leg strap.

4) The medical device of claim 1, further comprising a knee joint positioned between the rotatable hip joint and the foot support, wherein the lower linkage comprises:
a first lower linkage component configured to couple the rotatable hip joint to the knee joint;
a second lower linkage component configured to couple the knee joint to the foot support.

5) The medical device of claim 4, wherein at least one of the knee joint and the hip joint are configured to be selectively lockable.

6) The medical device of claim 4, wherein at least one of the knee joint and the hip joint are configured to have a reduced range of motion.

7) The medical device of claim 1, wherein the foot support further comprises an ankle joint, wherein the ankle joint is configured to be selectively lockable at an ankle angle.

8) The medical device of claim 1, wherein the foot support further comprises a foot extension configured to mount under a foot of the user.

9) The medical device of claim 1, wherein at least one of the upper linkage and the lower linkage are configurable to have an adjustable length.

10) A method for fitting a medical device to a user, the method comprising:
setting an upper linkage length based on a distance between a hip of the user and an armpit region of the user;
setting a lower linkage length based on a distance from a ground surface to the hip of the user; and
coupling the medical device to the user.

11) The method of claim 10, wherein setting the lower linkage length comprises:
setting a first lower linkage length based on a distance between the hip of the user and a knee of the user; and
setting a second lower linkage length based on a distance from the ground surface to the knee of the user.

12) The method of claim 10, further comprising setting a hip rotational range for a hip joint of the medical device.

13) The method of claim 12, wherein the hip rotational range is zero such that the hip is fixed at a given angle.

14) The method of claim 10, further comprising setting a knee rotational range for a knee joint of the medical device.

15) The method of claim 14, wherein the knee rotational range is zero such that the knee is fixed at a given angle.

16) The method of claim 10, further comprising setting an ankle rotational range for an ankle joint of the medical device.

17) The method of claim 16, wherein the ankle rotational range is zero such that the ankle is fixed at a given angle.

18) The method of claim 10, wherein coupling the medical device to the user comprising strapping the medical device to the user.

19) The method of claim 19, wherein strapping the medical device to the user comprises one or more of affixing a chest strap from the medical device to the user, affixing a waist strap from the medical device to the user, affixing a thigh strap from the medical device to the user, and affixing a calf strap from the medical device to the user.

20) An apparatus comprising:
a shoulder support configured to contact an armpit region of a user;
a rotatable hip joint;
a rotatable knee joint;
a rotatable ankle joint,
a foot support coupled to the rotatable ankle joint;
an upper linkage configured to couple the shoulder support to the rotatable hip joint;
a thigh linkage configured to couple the rotatable hip joint to the rotatable knee joint;
a tibia linkage configured to couple the rotatable knee joint to the rotatable ankle joint;
a plurality of straps, wherein the straps are configured to couple the apparatus to the user; and
wherein at least one of the rotatable hip join, the rotatable knee joint, or the rotatable ankle joint is configured to be selectively locked at a predetermined angle.
